(19) United States
(12) Patent Application Publication
(10) Pub. No.: US 2014/0297692 A1
(43) Pub. Date: Oct. 2, 2014

(54) ENCODER, ENCODING METHOD, AND PROGRAM

(71) Applicant: Kabushiki Kaisha Toshiba, Tokyo (JP)

(72) Inventor: Yusuke Doi, Kanagawa (JP)

(73) Assignee: KABUSHIKI KAISHA TOSHIBA, Tokyo (JP)

(21) Appl. No.: 14/196,004

(22) Filed: Mar. 4, 2014

(30) Foreign Application Priority Data
Mar. 27, 2013 (JP) 2013-066955

(51) Int. Cl. G06F 17/30

(52) U.S. Cl. CPC G06F 17/30292
USPC 707/803

(57) ABSTRACT

According to one embodiment, an encoder includes: a coding module configured to encode an XML document from a start position toward an end position of the XML document, and detect an expended element located between the start position and the end position of the XML document; and a combining module configured to generate a third EXI grammar by combining a first EXI grammar and a second EXI grammar, the first EXI grammar being generated according to a basic schema, and the second EXI grammar being generated according to an extended schema that prescribes a structure of the extended element, wherein the coding module encodes the XML document according to the first EXI grammar from the start position until detection of the extended element, and encodes the XML document according to the third EXI grammar after the detection of the extended element.

### CROSS REFERENCE TO RELATED APPLICATION(S)

The application is based upon and claims the benefit of priority from Japanese Patent Application No. 2013-066955 filed on Mar. 27, 2013, the entire contents of which are incorporated herein by reference.

### BACKGROUND

1. Field

The present invention relates to an encoder, an encoding method, and a related program.

2. Description of the Related Art

EXI (Efficient XML Interchange) is proposed which is a standard for efficient and high-speed data processing. EXI is a technique for generating a compact XML binary expression using an XML schema, and is defined in Non-patent document 1.

One method of conversion from an XML format to an EXI format is a method that is based on an EXI grammar (schema-informed grammar) generated from an XML schema. As is well known, an XML schema describes the structure of an XML document. An EXI grammar is generated from an XML schema by a known method.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a block diagram of an encoder 100 according to an embodiment of the present invention.

FIG. 2 is a flowchart showing an example operation of the encoder 100.

FIG. 3 shows an example basic schema.

FIG. 4 shows a first example extended schema.

FIG. 5 shows a second example extended schema.

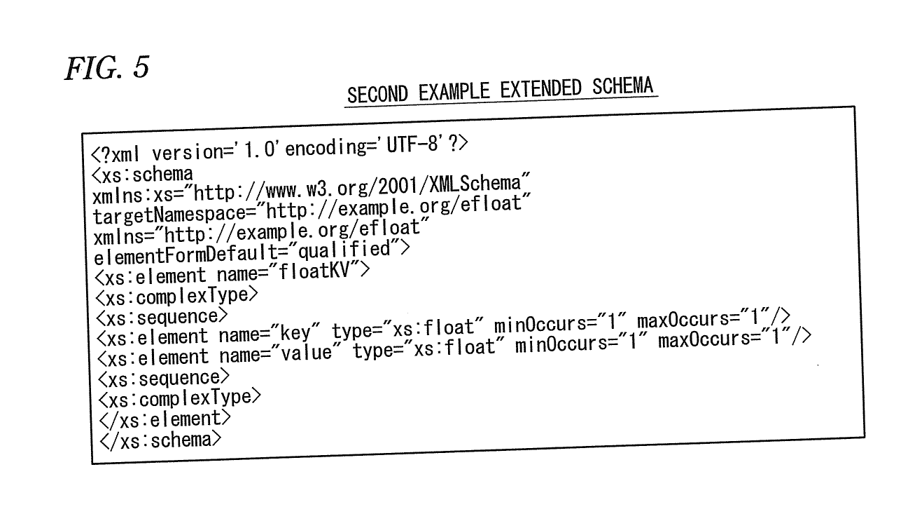

FIG. 6 shows an example XML document.

FIG. 7 is state transition diagrams of a document grammar and a type grammar of an EXI grammar that is derived from the basic schema shown in FIG. 3.

FIG. 8 is state transition diagrams of a document grammar and a type grammar of an EXI grammar that is derived from the extended schema shown in FIG. 4.

FIG. 9 is state transition diagrams of a document grammar and a type grammar of an EXI grammar generated by combining the EXI grammar derived from the basic schema shown in FIG. 3 and the EXI grammar derived from the extended schema shown in FIG. 4.

FIG. 10 shows an example string table initialization definition of an EXI grammar which is generated from the basic schema defined as shown in FIG. 3.

FIG. 11 shows an example string table initialization definition of an EXI grammar which is generated from the extended schema defined as shown in FIG. 4.

FIG. 12 shows an example string table initialization definition which is generated when the EXI grammar basic schema defined as shown in FIG. 3 and the EXI grammar generated from the extended schema defined as shown in FIG. 4 are combined together.

FIG. 13 is a block diagram of an encoder 200 according to a modification of the embodiment of the invention.

### DETAILED DESCRIPTION

According to one embodiment, an encoder includes: a coding module configured to encode an XML document from a start position toward an end position of the XML document, and detect an expended element located between the start position and the end position of the XML document; and a combining module configured to generate a third EXI grammar by combining a first EXI grammar and a second EXI grammar, the first EXI grammar being generated according to a basic schema, and the second EXI grammar being generated according to an extended schema that prescribes a structure of the extended element, wherein the coding module encodes the XML document according to the first EXI grammar from the start position until detection of the extended element, and encodes the XML document according to the third EXI grammar after the detection of the extended element.

An embodiment of the present invention will be hereinafter described with reference to the drawings. The same elements in the drawings are given the same reference symbol and will not be described redundantly.

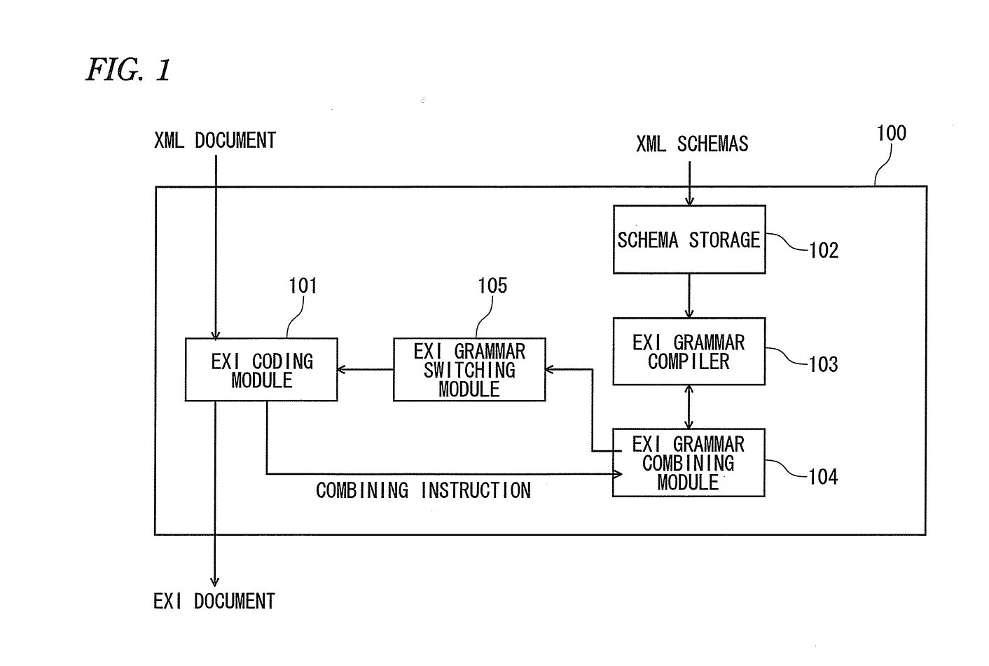

FIG. 1 is a block diagram of an encoder 100 according to the embodiment of the invention. The encoder 100 is equipped with an EXI coding module 101, a schema storage 102, an EXI grammar compiler 103, an EXI grammar combining module 104, and an EXI grammar switching module 105.

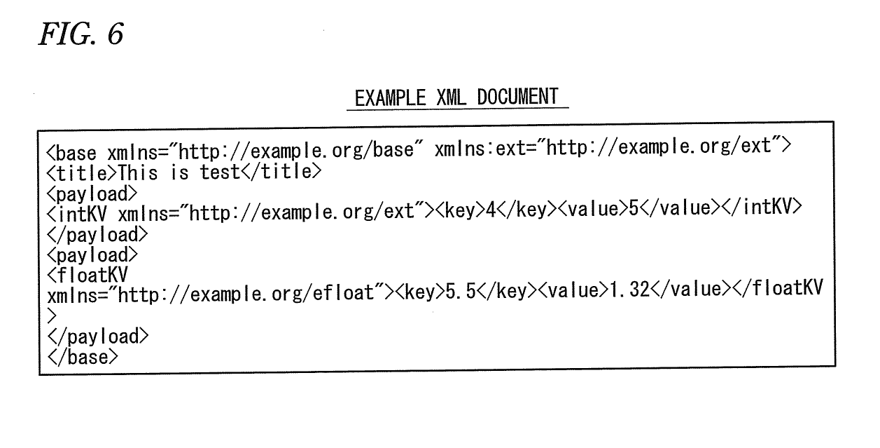

The EXI coding module 101 encodes an XML document from its start position toward its end position. FIG. 6 shows an example XML document which starts from “<base” on the first line and ends at “/base>” on the 11th line. The EXI coding module 101 encodes the XML document according to a predetermined EXI grammar from the start position to a position immediately before an extended element. For example, the EXI coding module 101 encodes the XML document according to the predetermined EXI grammar from the start position until detection (described later) of an extended element. The predetermined EXI grammar is generated on the basis of a basic schema A which is a schema for the entire XML document.

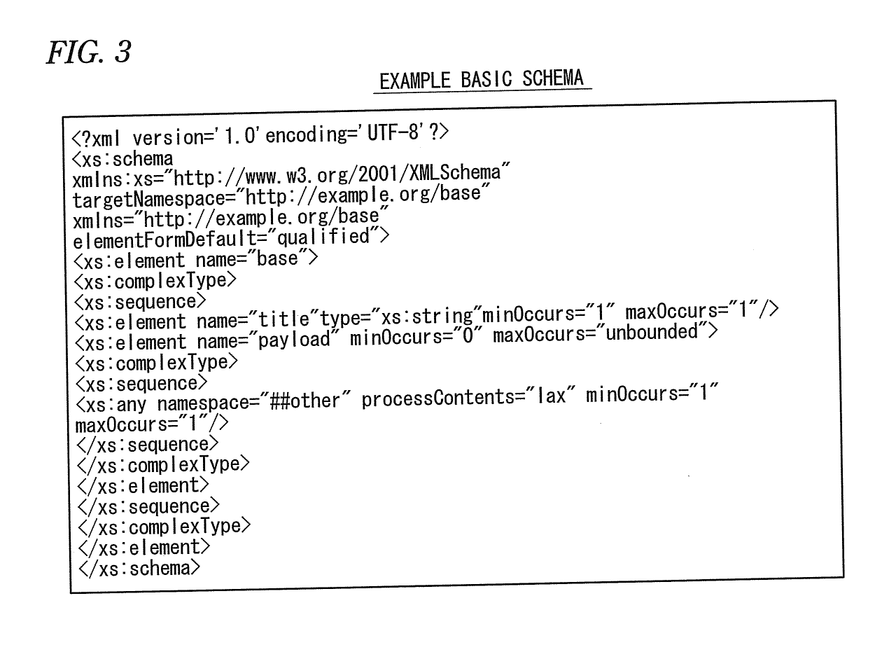

As the EXI coding module 101 encodes the XML document from its start position toward its end position, the EXI coding module 101 detects whether or not the XML document has an extended element that is defined by a schema other than the basic schema A. If detecting an extended element, the EXI coding module 101 instructs the EXI grammar combining module 104 to combine an EXI grammar generated from a schema that defines the detected extended element and the an EXI grammar generated from the basic schema A. The EXI coding module 101 detects an extended element by finding an element corresponding to a wild card in interpreting the XML document while referring to the basic schema A. More specifically, in the example of FIG. 6, the contents of each <payload> element are interpreted according to the rule of <xs:any> shown in FIG. 3 and each <payload> element is thereby judged an element corresponding to a wild card. In this example, an <intKV> element and a <floatKV> element are each an element corresponding to a wild card. Because the <intKV> element and the <floatKV> element are defined in an “http://example.org/ext” name space and an “http://example.org/efloat” name space, respectively, the extended elements can be referred to using the respective name spaces as keys. A schema corresponding to each extended element is detected by detecting a schema ID for identification of the schema. In instructing the EXI grammar combining module 104, the EXI coding module 101 may communicate a schema ID to it.

After detecting an extended element, the EXI coding module 101 EXI-encodes the extended element according to a combined EXI grammar and outputs a generated part of an EXI document. Upon completion of the EXI coding of the extended element, the EXI coding module 101 restarts EXI-encoding the XML document according to the basic schema A. The EXI coding of the extended element can be finished by detecting its end tag. In the example of FIG. 6, </intKV> and </floatKV> are end tags.

The schema storage 102 stores the basic schema A and a single or plural extended schemas. The schema storage 102 may store schemas other than extended schemas. Schemas may be either stored in the schema storage 102 in advance or input to the schema storage 102 when the XML document is input to the EXI coding module 101. The schema storage 102 may store the basic schema A and extended schemas in such a manner that they are correlated with schema IDs for identification of them. For example, where the schema storage 102 is stored with the basic schema A and extended schemas B-D, they are stored so as to be correlated with respective schema IDs for identification of them.

The EXI grammar compiler 103 generates an EXI grammar using a schema stored in the schema storage 102. For example, if instructed to generate an EXI grammar by combining EXI grammars generated from the basic schema A and an extended schema B, the EXI grammar compiler 103 may either generate an EXI grammar corresponding to the extended schema B or use a pre-generated EXI grammar corresponding to the extended schema B. The EXI grammar compiler 103 passes the generated combined EXI grammar to the EXI grammar combining module 104.

When instructed by the EXI coding module 101 to combine EXI grammars, the EXI grammar combining module 104 combines an EXI grammar corresponding to the basic schema A and an EXI grammar corresponding to an extended schema. A specific combining method will be described later in detail. The EXI grammar combining module 104 passes the generated combined EXI grammar to the EXI grammar switching module 105.

When receiving the combined EXI grammar from the EXI grammar combining module 104, the EXI grammar switching module 105 instructs the EXI coding module 101 to perform EXI coding according to the combined EXI grammar.

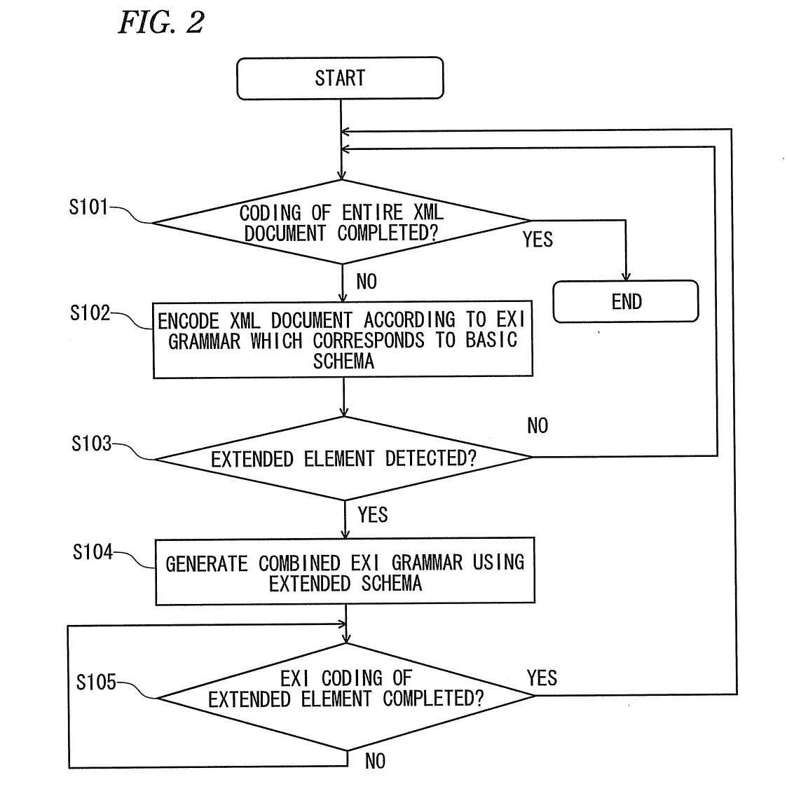

Next, a description will be made of an example operation of the encoder 100. FIG. 2 is a flowchart showing an example operation of the encoder 100. This is just an example operation;

adaptation to a case that presence of an extended element in an extended element is permitted is made by, for example, recursively performing a process equivalent to the following process.

An XML document is received in a divisional manner. If it is judged that coding of the entire XML document has not been completed yet (S101: no), at step S102 the EXI coding module 101 encodes the input XML document from its XML start position toward its end position according to an EXI grammar corresponding to the basic schema A. At step S103, the EXI coding module 101 detects whether or not the input XML document contains an extended element that is defined by a schema that is different from the basic schema A. This is done by, for example, finding an element that is contained in the XML document and corresponds to a wild card.

If detecting an extended element (S103: yes), the EXI coding module 101 sends, to the EXI grammar combining module 104, an EXI grammar combining instruction which includes a schema ID corresponding to the detected extended element. At step S104, the EXI grammar combining module 104 combines the EXI grammar corresponding to the basic schema A and an EXI grammar corresponding to the extended schema that is identified by the schema ID according to the EXI grammar combining instruction. The EXI grammar combining module 104 communicates the combined EXI grammar to the EXI grammar switching module 105, which instructs the EXI coding module 101 to perform EXI coding according to the combined EXI grammar. The EXI coding module 101 EXI-encodes the extended element according to the combined EXI grammar. Upon completion of the coding of the extended element (S105: yes), the EXI coding module 101 restarts EXI coding according to the EXI grammar corresponding to the basic schema A (step S102). Upon completion of the entire XML document, the process is finished.

As in the above-described operation, the encoder 100 generates an EXI grammar which reflects an extended schema corresponding to an extended element that is defined by a wild card, whereby the code rate of an XML document containing the wild-card-defined extended element can be increased.

The EXI coding efficiency can be increased further by taking certain measures (described later) in combining the EXI grammar corresponding to the basic schema A and an EXI grammar corresponding to an extended element. As described later in detail, the size of an EXI grammar generated by combining the EXI grammar corresponding to the basic schema A and an EXI grammar corresponding to an extended element is reduced.

Although the following description will be directed to EXI coding, a similar concept also applies to EXI decoding.

### (Combining of EXI Grammar)

In the following description, an EXI grammar that is used for coding of an XML document will be denoted by Gₑᵢ (i: integer). And an EXI grammar that is used for the coding from the beginning of the EXI coding of the XML document is denoted by Gₑ₀. EXI grammars that are used in order for coding of extended elements are denoted by Gₑ₁, Gₑ₂, . . . , respectively. A basic schema, that is, an XML schema used at the beginning of the coding of the XML document, is called a schema A. It is assumed that there are schemas B and C which correspond to extended elements, and EXI grammars corresponding to the schemas A, B, and C are denoted by G_{A}, G_{B}, and G_{C}, respectively.

In the following, EXI grammars which are used from the start to the end of coding of an XML document will be described. The EXI grammar that is used at the beginning of the coding of the XML document is given by Equation (1) because the entire document is defined by the schema A:

Gₑ₀=G_{A} (1)

Then the EXI grammar used actually is switched at the start of an extended element B which is defined by the schema B. If the EXI grammar used actually were simply switched to G_{B}, the newly employed EXI grammar would not include definitions of elements that are used in the extended element B and defined by the schema A. In view of this, an EXI grammar generated by combining G_{A} and G_{B} is employed for EXI coding of the extended element B. The EXI grammar Gₑ₁ to be used for the EXI coding of the extended element B is given by the following Equation (2):

Gₑ₁=G_{A}+G_{B} (2)

The EXI grammar used actually is switched from Gₑ₁ to Gₑ₀ at the end of the extended element B in the XML document.

The EXI grammar used actually is then switched at the start of an extended element C which is defined by the schema C. An EXI grammar generated by combining G_{A} and G_{C} is employed for EXI coding of the extended element C. The EXI grammar Gₑ₂ to be used for the EXI coding of the extended element C is given by the following Equation (3):

Gₑ₂=G_{A}+G_{C} (3)

The EXI grammar used actually is switched from Gₑ₂ to Gₑ₀ at the end of the extended element C in the XML document.

Although in Equations (2) and (3) the symbol “+” is used, this symbol represents the combining of two EXI grammars and does not mean simple addition.

### (Definition of EXI Grammar)

Next, a description will be made of the definition of the EXI grammar. The EXI grammar Gₑ is a grammar which is provided with a document grammar D, a type grammar T, and a string table initialization definition I. The EXI grammar Gₑ can be expressed by the following Equation (4):

Gₑ={D, T, I} (4)

The document grammar D is a set of generative grammars. The type grammar T is a set of individual type grammars which are defined for respective types which are defined by an XML schema, and is, in general, a dictionary-type definition having type names as keys. For example, for an individual type name q ∈ Q which is a set of type names defined by a schema, T[q] is a set of generative grammars corresponding to the individual type name q. ∀q ∈ Q, T[q]≠ φ.

The string table initialization definition I is formed by a URI partition U which is defined by EXI and a set L of local name partitions that belong to respective URIs. The string table initialization definition I can be expressed by the following Equation (5):

I={U, L} (5)

U is a single string table (an ordered set of character strings). L is a dictionary-type definition in which each URI u e U serves as a key, and each local name partition is a character string table. ⋆u ∈ U, L[u]≠φ, where L[u] is a local name partition having u as a key.

### (Measures Taken in Generating a Combined EXI Grammar)

Next, a description will be made of measures that are taken in generating a combined EXI grammar. The following measures can be taken in combining the EXI grammar corresponding to the basic schema and an EXI grammar corresponding to an extended element. The EXI grammar derived from the basic schema, an EXI grammar derived from an extended element, and a combined EXI grammar are denoted by G1, G2, and G3, respectively. A document grammar, a type grammar, and a string table initialization definition of the combined EXI grammar G3 are denoted by D3, T3, and I3, respectively. Thus, the following Equation (6) holds:

G3=G1+G2={D3, T3, I3} (6)

The symbol “+,” which is used for the sake of convenience (it does not mean ordinary addition), is a unique symbol representing the combining of two EXI grammars.

The efficiency of EXI coding can be increased by taking simple measures described below for D3, T3, and I3 in combining the EXI grammar corresponding to the basic schema and an EXI grammar corresponding to the extended element.

Because D3 corresponds to a document definition of the extended element defined by the extended schema, the document definition of the extended element defined can be employed as D3. That is, D3 can be such as to be given by the following Equation (7):

D3=D2 (7)

Alternatively, D3 may be a combination of the elements of D2 and D1.

Since it is necessary that T3 include the definitions of the set of types defined by the extended schema and the set of types defined by the basic schema, T3 can be such as to be given by the following Equation (8), that is, it is the union of sets T1 and T2:

T3=T1∪T2 (8)

As mentioned above, the type grammar T has type names and generative grammars corresponding to the type names. Therefore, T1 and T2 may have generative grammars that are defined differently while corresponding to the same type name. This may be regarded as an error according to an implementation policy. Or the definitions in T2 or T1 may be employed as definitions of generative grammars of T3.

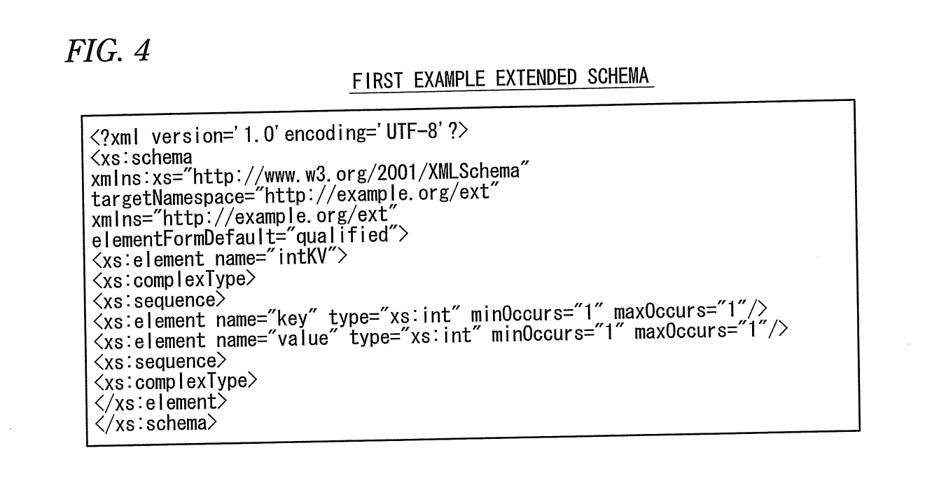

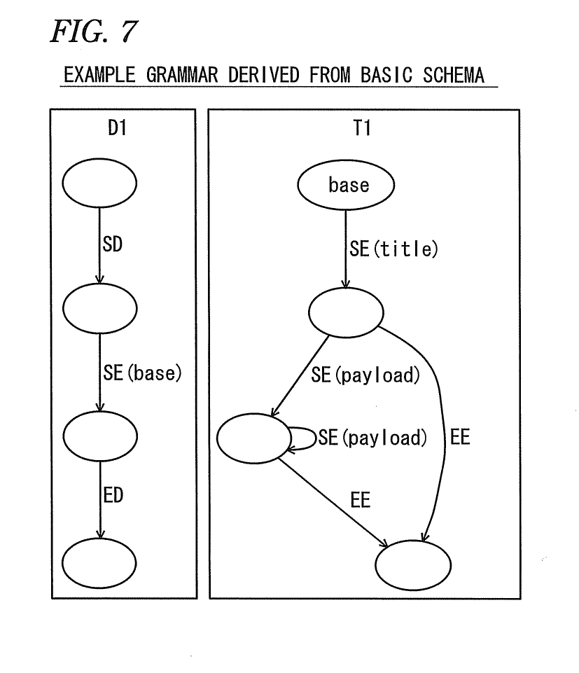

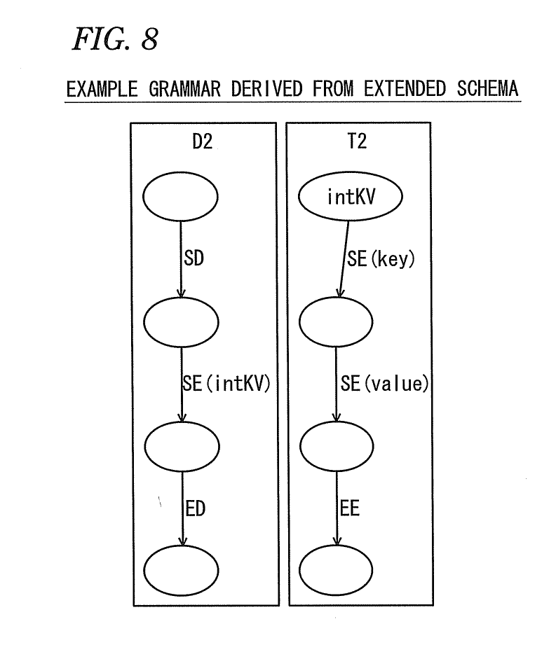

FIG. 7 is state transition diagrams of a document grammar and a type grammar that are derived from a basic schema that is defined as shown in FIG. 3. The state transition diagram of the document grammar starts from “Document,” and the state transition diagram (right-hand part of FIG. 7) of the type grammar starts from “base.” FIG. 8 is state transition diagrams of a document grammar and a type grammar that are derived from an extended schema that is defined as shown in FIG. 4.

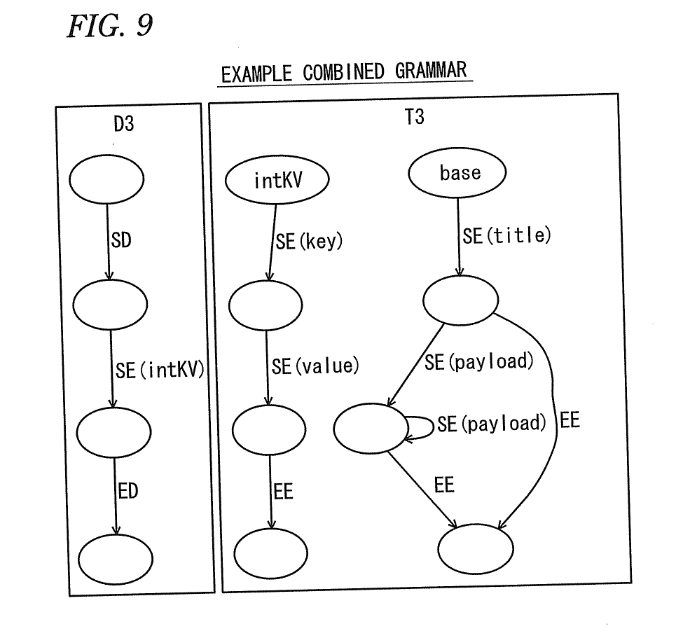

FIG. 9 is state transition diagrams of a document grammar and a type grammar of an EXI grammar generated by combining the EXI grammar derived from the basic schema shown in FIG. 3 and that derived from the extended schema shown in FIG. 4. The EXI grammar shown in FIG. 9 is different from that shown in FIG. 7 in that the document grammar is replaced by “intKV” and an intKV type grammar is added. That is, the document grammar shown in FIG. 9 is the same as that of the EXI grammar derived from the extended schema, and the type grammar shown in FIG. 9 is the union of the set of elements of the type grammar of the EXI grammar derived from the basic schema and that of the type grammar of the EXI grammar derived from the extended schema.

The following combining manipulation is defined for the string table initialization definition I:

$$\begin{matrix}I 3 = I 1 + I 2 = \{ U 1 , L 1 \} + \{ U 2 , L 2 \} \\ = \{ U 3 , L 3 \}\end{matrix} \qquad ( 9 )$$

As mentioned above, U is an ordered set of character strings. U3 may be any set as long as it is the union of sets U1 and U2.

On the other hand, the memory implementation efficiency and the coding efficiency can be increased further by performing a combining manipulation given by the following Equation (10) or (11):

U3=U1⊕U2 (10)

U3=U2⊕U1 (11)

The symbol “⊕” that is used in Equations (10) and (11) will be described below. For example, p ⊕ q where p and q are ordered sets of character strings means a set obtained by combining p and q in such a manner than the order, in p, of those elements of the ordered set p which are not included in the ordered set q is maintained.

As mentioned above, L3 is a dictionary-type one which has sets of character strings as values with each URI character string contained in U3 serves as a key, and each local name partition is a character string table. L3 can be expressed by the following Equation (12) or (13) for u ∈ U3:

L3=L1[u]⊕L2[u] (12)

L3=L2[u]⊕L1[u] (13)

If L[u] is not defined, L3 is made an empty set. Since U3 is the union of the sets U1 and U2, a relationship Vu ∈ U3, L3[u] ≠ φ holds.

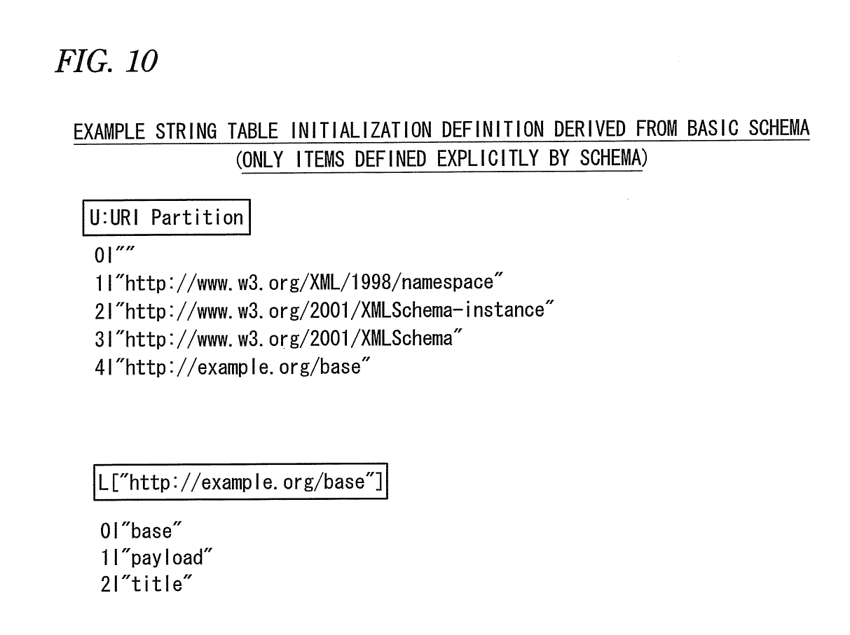

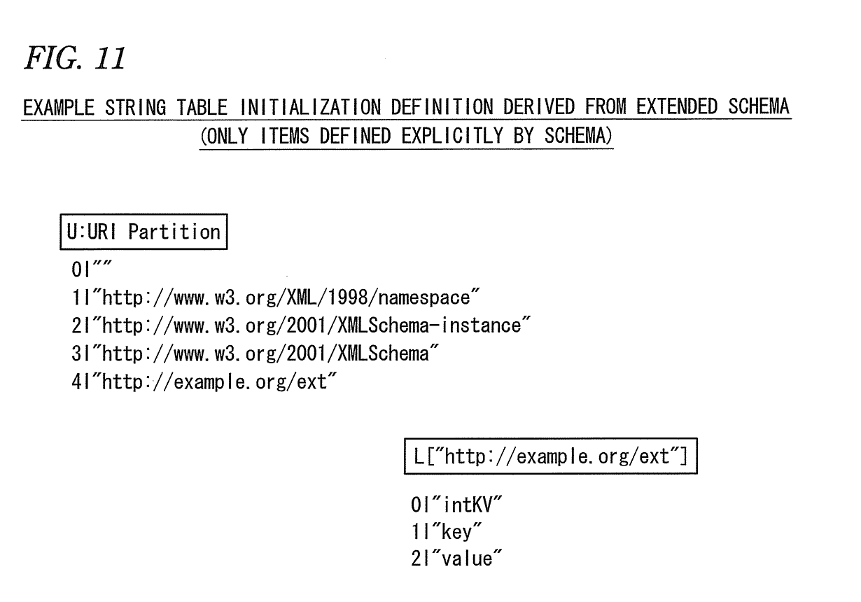

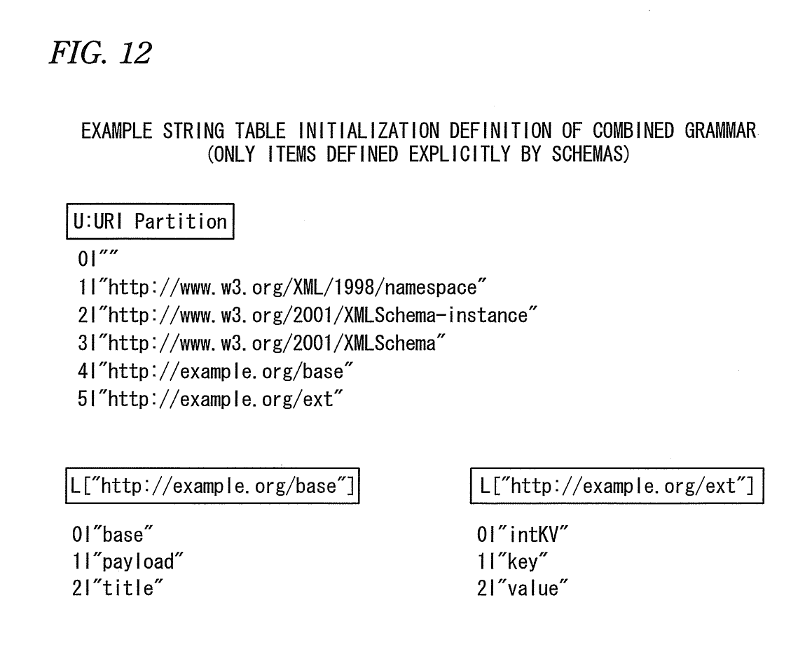

FIG. 10 shows an example string table initialization definition of an EXI grammar which is generated from the basic schema defined as shown in FIG. 3. FIG. 11 shows an example string table initialization definition of an EXI grammar which is generated from the extended schema defined as shown in FIG. 4. FIG. 12 shows an example string table initialization definition which is generated when the EXI grammar basic schema defined as shown in FIG. 3 and the EXI grammar generated from the extended schema defined as shown in FIG. 4 are combined together. Each string table initialization definition is assigned numbers. When a character string is necessary in an EXI stream, it is referred to using its number. For the sake of simplicity, default local name partitions which are defined in the EXI specification are not shown (this also applied to the following).

In the example string table initialization definition of the combined grammar shown in FIG. 12, “http://example.org/ext” is added as a new item of the URI partition and a local name partition L[http://example.org/ext] having this URI as a key is added. In this example, the items of the URL partition happen to be arranged in alphabetical order. Even if an URI to be added were one that should be located early in alphabetical order, it is added at the end of the string table initialization definition as a result of the ⊕ operation.

The memory implementation efficiency and the coding efficiency can be increased by taking the above-described measured in combining EXI grammars.

Now, a more detailed description will be made of how an XML document including a wild card is encoded actually. To encode an extended element corresponding to a wild card, it is necessary to combine an EXI grammar derived from generation rules (e.g., extended schema) corresponding to the extended element with an EXI grammar derived from a basic schema. In terms of the EXI specification, this processing is equivalent to “selfContained” (SC) of “fidelity option.” In a selfContained-permitted XML document, an element corresponding to “selfContained” can be encoded by a highly independent coding method. A generation rule indicating it is added to the grammar (refer to Section 8.5.4.4.1 of Non-patent document 1).

Likewise, in a selfContained-permitted EXI document, generation rules corresponding to an EXI extended element which is described according to a combined grammar can be described. A destination EXI stream of a transition from the rules is encoded or decoded according to a combined grammar as in the case of the selfContained processing, whereby the advantages of the embodiment can be obtained. To help select a combined grammar, transfer result EXI code may include a schema ID (string). Interpretation of the schema ID is left to each application. For example, in the case of XMPP, an XEP number can be used because serial numbers are assigned to documents called XEP which relate to this measure.

The decoding side cannot perform decoding if it does not know an extended schema, even if the encoding side knows it. Because of the nature of EXI, a part that cannot be decoded cannot even be skipped and hence the ensuing items cannot be used. On the other hand, in nature the XML requires that extension be done freely; for example, it is not practical to implement the same extended schema group in all nodes that use EXI in communication. In view of this, to realize skipping of an extended-schema-unimplemented node, transition result EXI code may include a coding length of a part corresponding to an extended element.

EXI makes it possible to encode a character string that appears repeatedly in an XML document by constructing a table of character strings called a string table. More specifically, a character string that appeared in an XML stream in the past can be encoded using a number that indicates it.

There are two methods for encoding an extended element, that is, a method in which a string table is initialized at the beginning of the encoding of the extended element (equivalent to “selfContained” in EXI) and a method in which a string table is not initialized but used continuously. Where a string table continues to be used, code becomes context-dependent whereas more efficient coding is enabled. On the other hand, where a string table is initialized, the coding efficiency is lower than in the case where it continues to be used whereas an advantage is obtained that code does not become context-dependent.

Therefore, it would be appropriate to use, according to a manner of use, one of the method in which a string table is initialized and the method in which a string table continues to be used. For example, in the case where a decoder-side process that does not understand an extended element copies it and transfers it to another receiver without decoding it, the method in which a string table is initialized is preferable. For example, in the case of XMPP, an appropriate approach would be as follows. A communication from a server to a client is increased in efficiency by using a string table continuously instead of initializing it in encoding an extended element. In a communication from a client to the server, a string table is initialized to enable transfer of an extended element from the server to another server or client.

In the embodiment of the invention, at the beginning of an extended element of an XML document, a flag indicating whether to initialize a string table or continue to use it may be added. A flag indicating whether to continue to use a string table that has been updated by character string information contained in an extended element or restore a string table that was employed at the beginning of the encoding of the extended element may also be added at the end of the extended element of an XML document.

### <Modification>

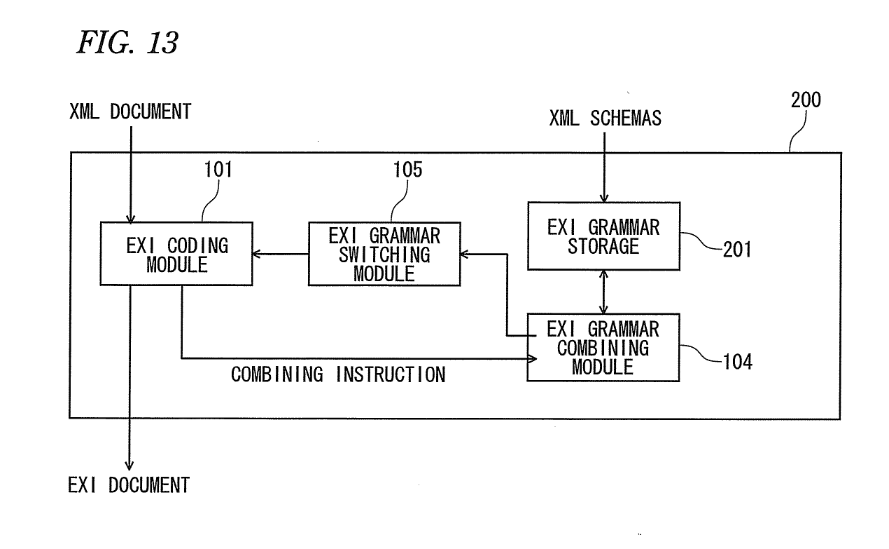

FIG. 13 shows an encoder 200 according to a modification of the embodiment. The encoder 200 is different from the encoder 100 in being equipped with an EXI grammar storage 201 and not being equipped with the schema storage 102 or the EXI grammar compiler 103.

The encoder 200 receives an EXI grammar generate from the basic schema A and an EXI grammar (s) generate from an extended schema (s) and stores the received EXI grammars in the EXI grammar storage 201 in advance. The EXI grammar storage 201 may store EXI grammars in such a manner that they are correlated with schema IDs for identification of schemas, respectively.

Although the above description is directed to encoding, a code sequence obtained by encoding an extended element efficiently can be decoded by a decoding process in which a process equivalent to the above-described coding process is executed in reverse order. More specifically, when a generation rule indicating an extended element is found in a stream, a schema ID, an extended element data length, and a string table initialization flag are read out, a grammar corresponding to the schema ID is read out, and a grammar for processing the extended element is generated by combining the read-out grammar with the grammar used currently. The extended element part is read out using the combined grammar, and the original grammar is restored at the end of the extended element (i.e., when an element end (EE) event which corresponds to the start (SE) of the extended element is generated). In this manner, EXI code that was encoded efficiently can be decoded efficiently.

The above-described embodiment provides an advantage that the code rate of an XML document containing an extended element that is defined by a wild card can be increased by generating an EXI grammar which reflects an extended schema corresponding to the extended element defined by a wild card. The memory implementation efficiency and the coding efficiency can be increased further by taking proper measures in generating a combined EXI grammar.

The encoder 100 can also be implemented by using, for example, a general-purpose computer as basic hardware. That is, the EXI coding module 101, the schema storage 102, EXI grammar compiler 103, the EXI grammar combining module 104, and the EXI grammar switching module 105 can be implemented by causing a processor of the computer to run programs. In this case, the programs may be either preinstalled in the computer or installed in the computer when necessary by delivering them over a network or in such a manner that they are stored in a storage medium such as a CD-ROM. The schema storage 102 can be implemented using, as appropriate, a storage medium incorporated in or externally connected to the computer, such as a memory, a hard disk drive, a CD-R, CD-RW, DVD-RAM, or a DVD-R.

Although the embodiment of the invention has been described above, it is just an example and should not be construed as restricting the scope of the invention. This novel embodiment may be practiced in various other forms, and part of it may be omitted, replaced by other elements, or changed in various manners without departing from the spirit and scope of the invention. These modifications are also included in the invention as claimed and its equivalents.

What is claimed is:

1. An encoder characterized by comprising:
a coding module configured to encode an XML document from a start position toward an end position of the XML document, and detect an expended element located between the start position and the end position of the XML document; and
a combining module configured to generate a third EXI grammar by combining a first EXI grammar and a second EXI grammar, the first EXI grammar being generated according to a basic schema, and the second EXI grammar being generated according to an extended schema that prescribes a structure of the extended element, wherein
the coding module encodes the XML document according to the first EXI grammar from the start position until detection of the extended element, and encodes the XML document according to the third EXI grammar after the detection of the extended element.

2. The encoder according to claim 1, further comprising
a first storage module configured to hold the first EXI grammar and the second EXI grammar.

3. The encoder according to claim 1, further comprising:
a second storage module configured to hold the basic schema and the extended schema; and
a generating module configured to generate the first EXI grammar and the second EXI grammar according to the basic schema and the extended schema, respectively.

4. The encoder according to claim 1, wherein
the coding module detects an element corresponding to a wild card, in the basic schema in the XML document, as the extended element.

5. The encoder according to claim 3, wherein:
the second storage module stores plural schemas including the extended schema;
the coding module detects a schema ID for identification of an extended schema that prescribes a structure of the extended element in detecting an extended element; and
the combining module generates a third EXI grammar by combining the first EXI grammar and a second EXI grammar that is generated according to the extended schema that is identified by the schema ID detected by the coding module among the plural schemas stored in the second storage module.

6. The encoder according to claim 1, wherein:
the first EXI grammar has a first document grammar, a first type grammar and a first string table initialization definition;
the second EXI grammar has a second document grammar, a second type grammar and a second string table initialization definition; and
the combining module employs the second document grammar as a document grammar of the third EXI grammar in generating the third EXI grammar.

7. The encoder according to claim 1, wherein:
the first EXI grammar has a first document grammar, a first type grammar and a first string table initialization definition;
the second EXI grammar has a second document grammar, a second type grammar and a second string table initialization definition; and
the combining module employs a union of a set of elements of the first type grammar and a set of elements of the second type grammar, as a type grammar of the third EXI grammar, in generating the third EXI grammar.

8. The encoder according to claim 1, wherein:
the first EXI grammar has a first document grammar, a first type grammar, and a first string table initialization definition which includes a first URI partition which is an ordered set of character strings;
the second EXI grammar has a second document grammar, a second type grammar, and a second string table initialization definition which includes a second URI partition which is an ordered set of character strings;
the third EXI grammar has a string table initialization definition which includes a third URI partition which is an ordered set of character strings; and
in a case that the combining module generates the third EXI grammar, the third URI partition of the string table initialization definition of the third EXI grammar is a set including elements of the set of the second URI partition, which are not included in the set of the first URI partition and are located after the ordered set of the first URI partition so that order of character strings of those elements in the set of the second URI partition is maintained, or a set including elements of the set of the first URI partition, which are not included in the set of the second URI partition and are located after the ordered set of the second URI partition so that order of character strings of those elements in the set of the first URI partition is maintained.

9. The encoder according to claim 8, wherein:
the first string table initialization definition further includes first local name partitions which belong to URIs contained in the first URI partition;
the second string table initialization definition further includes second local name partitions which belong to URIs contained in the second URI partition;
the string table initialization definition of the third EXI grammar further includes third local name partitions which belong to URIs contained in the third URI partition; and
in a case that the combining module generates the third EXI grammar, the third local name partitions, belonging to the URIs contained in the third URL partition, is a set including elements of a set of the second local name partitions, which are not included in a set of the first local name partitions and are located after the set of the first local name partitions so that order of those elements in the set of the second local name partitions is maintained, or a set including elements of the set of the first local name partitions, which are not included in the set of the second local name partitions and are located after the set of the second local name partitions so that order of those elements in the set of the first local name partitions is maintained.

10. The encoder according to claim 1, wherein
the coding module encodes an input XML document according to a string table which correlates character strings appearing in the input XML document with corresponding pieces of coding information, and performs a control as to whether to initialize or continue to use a string table that has been generated before the extended element by detecting a flag indicating which of the two options should be taken at a start of the extended element.

11. The encoder according to claim 10, wherein
the coding module performs a control as to whether to continue to use a string table that has been updated according to the contents of the extended element or restore a string table at the time of the start of the extended element by detecting a flag indicating which of the two options should be taken at an end of the extended element.

12. A non-transitory computer-readable medium containing program instructions for controlling an electronic device, wherein execution of the program instructions by one or more processors of a computer system causes the one or more processors to:
encoding an XML document from a start position toward an end position of the XML document, and detecting an expended element located between the start position and the end position of the XML document; and
generating a third EXI grammar by combining a first EXI grammar that is generated according to a basic schema and a second EXI grammar that is generated according to an extended schema which prescribes a structure of the extended element, wherein:
the XML document is encoded according to the first EXI grammar from the start position until detection of the extended element, and the XML document is encoded according to the third EXI grammar after the detection of the extended element.

13. An encoding method comprising:
encoding an XML document from a start position toward an end position of the XML document, and detecting an expended element located between the start position and the end position of the XML document; and
generating a third EXI grammar by combining a first EXI grammar that is generated according to a basic schema and a second EXI grammar that is generated according to an extended schema which prescribes a structure of the extended element, wherein:
the XML document is encoded according to the first EXI grammar from the start position until detection of the extended element, and the XML document is encoded according to the third EXI grammar after the detection of the extended element.
